(19) United States
(12) Patent Application Publication
(10) Pub. No.: US 2004/0230484 A1
(43) Pub. Date: Nov. 18, 2004

(54) Method for generating and increasing patronage

(76) Inventor: Garrett M. Greenlee, Westerville, OH (US)

Correspondence Address: THOMPSON HINE L.L.P., 2000 COURTHOUSE PLAZA , N.E., 10 WEST SECOND STREET, DAYTON, OH, 45402, US

(21) Appl. No.: 10/845,796

(22) Filed: May 14, 2004

Related U.S. Application Data
(60) Provisional application No. 60/470,678, filed on May 15, 2003.

(51) Int. Cl. G06F 17/60

(52) U.S. Cl. 705/14

(57) ABSTRACT

A method for generating and increasing the sales and customer base of a business through referrals. A customer is incentivized to join a core customer group or “club” sponsored by the business with offers of perks available only to members. The new member is issued an account and is given referral cards. Using the cards, the member then makes referrals to prospective members, who present the cards to the business or alternatively mention the referring member by name. In exchange, the prospective members may receive discounts on their purchases for that visit or other one-time incentives. The member's account is credited with “points” for each referral. The member may also be awarded additional points corresponding to the amount and types of goods and/or services purchased by the referred customer and/or the member. Awards and prizes may be issued for members who reach threshold levels of accrued points.

This application claims priority to U.S. provisional application 60/470,678, filed May 15, 2003, the contents of which are hereby incorporated by reference.

### FIELD

This invention relates to a method for generating and increasing patronage. In particular, this invention relates to a method for recognizing a group of core customers, providing perks to the core customers, and incentivizing the core customers to regularly patronize a business, and refer additional customers.

### BACKGROUND

Many businesses, particularly retail stores and restaurants, depend on core groups of customers who regularly patronize the business. As a result, a number of programs have been implemented by businesses over the years to encourage customer loyalty through awards. An example is the “frequent flyer” program available at most airlines. A customer joins a frequent flyer program by entering personal and demographic information on an application form and submitting it to the airline. The customer subsequently receives a member number, and this number is entered into the airline's records each time the customer travels with the airline. The customer is typically credited with “mileage points” corresponding to the number of air miles flown with the airline. When the frequent flyer member has accrued a sufficient number of mileage points, he or she is eligible to redeem those points for awards such as passenger service class upgrades and discounted or free airline tickets. In many cases ancillary travel services, such as hotels and car rental agencies, offer frequent flyer miles as an incentive to earn the traveler's business. This practice is expanding to non-travel related products and services as well. A few examples include flowers, credit cards, long-distance phone service and mortgage lenders.

Another prevalent type of customer loyalty program is the “preferred shopper” card available from supermarkets whereby members are offered discounts on many items. A shopper joins the program by filling out an application form with personal and demographic information and submitting it to the supermarket. The member is subsequently issued a discount card, which must be presented at the time of check-out in order to receive the discounts. The customer's purchases may be tracked, providing the store with valuable data regarding consumer demographics and buying preferences, information that can be used to tailor the store's inventory to targeted groups of customers. The store may also offer coupons to the member, the coupons being targeted to match the member's preferences as determined by tracking the member's buying habits. Coupons may also be offered that are targeted toward products that compete with or are related to the member's purchases.

While these programs encourage repeat customer business, the programs do little to foster growth of the customer base beyond an incentive to obtain the discounts and benefits offered. Businesses using these types of customer loyalty programs must regularly promote and advertise in order to attract new customers. In some cases incentives may be offered to existing members who are able to attract new members. However, such incentives are generally ineffective as an ongoing means of increasing a business' customer base. Temporary sales events may bring in more customers, but often only for the term of the event. Further, the increase in customer traffic from the sale may provide the business with a lower income than desired due to price reductions or other incentives offered during the sales event. There is a need for a non-burdensome method of generating and increasing the sales and new customer base of a business. There is also a need for a method of retaining existing customers. There is a further need for a method to accomplish these goals as an ongoing, integral element of the business.

### SUMMARY

According to the present invention, a method is disclosed for generating and increasing the sales and customer base of a business through referrals. A customer is incentivized to join a core customer group or “club” sponsored by the business with offers of perks available only to members. A point-tracking account is created for the new member, and the new member is issued referral cards. The member then makes referrals by giving out the cards to prospective members, who may present the cards to the business (or, in the absence of cards, merely mention the referring member by name). In exchange, the prospective members may receive discounts on their purchases for that visit or other one-time incentives. The member's account is credited with a predetermined number of points for each referral. The member may also be awarded an additional quantity of points corresponding to the amount and types of goods and/or services purchased by the referred customer. The member may also receive points each time they visit the business, with additional points being awarded for goods and services purchased by the member during the visit. Awards and prizes may be issued for members who reach threshold levels of accrued points. Prizes and awards may be given for members who reach predetermined goals, such as the most accrued points in a period of time, total accrued points and the highest number of referrals in a period. In addition, a regularly scheduled drawing may be held for members who have made a predetermined minimum number of referrals, with an award being given to the winner of the drawing. This will effectively reward members for the ongoing process of referring business.

An object of the present invention is a method for generating and/or increasing patronage at a business. The method comprises the steps of granting membership in a club sponsored by the business to applicants meeting predetermined membership criteria and establishing a point account record for each member. At least one referral card is issued to at least one member. At least one referral card is distributed from at least one member to at least one referral who is a prospective customer of the business. The point account of each member is credited with a predetermined number of points for referrals who patronize the business and present the member's referral card or identify the member. Awards and/or prizes are issued to members who accumulate a predetermined number of points.

### BRIEF DESCRIPTION OF THE DRAWING

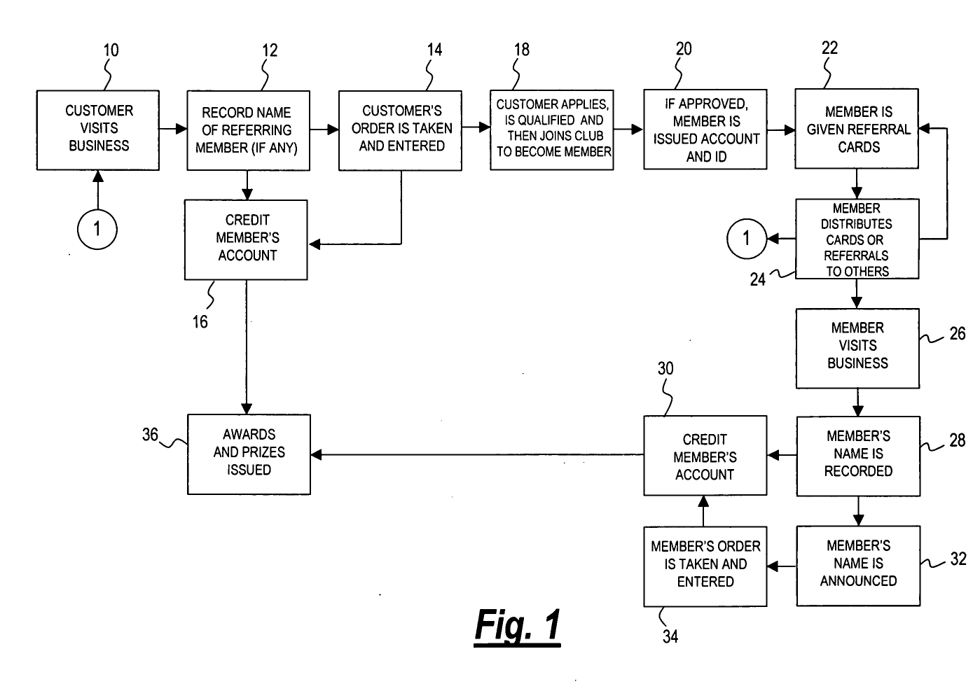

Further features of the inventive embodiments will become apparent to those skilled in the art to which the embodiments relate from reading the specification and claims with reference to FIG. 1, which is a block diagram of a method for generating and increasing customer patronage at a business according to an embodiment of the present invention.

### DETAILED DESCRIPTION

A block diagram of a method for generating and building a sales and customer base according to an embodiment of the present invention is shown in FIG. 1. At step 10 a customer visits the business, which may also be termed an “establishment.” The business may be any form of traditional brick-and-mortar store, outlet or restaurant, or may alternatively be an Internet-based or mail-order business. Further, the business may be independently operated, or may be part of a conventional chain or franchise.

If the customer has been referred to the business, the customer may present a referral card (discussed in detail below) provided to the customer by the referrer, or identify the referrer. The name of the person who referred the customer is recorded at step 12, and may be acknowledged by a host or wait staff. The recording at step 12 is preferably accomplished by electronic means, such as a conventional computer system. The computer system may include a wired or wireless network to facilitate data entry from any convenient location within the business. Alternatively, a handwritten or typed record may be made.

The person who referred the customer may be a member of a core customer group incentive program, termed generally herein as a “club.” The club may be sponsored by the business such that the business organizes the club, establishes operating procedures and rules, and manages the operation of the club. Sponsorship may also include sub-contracting to another business or organization at least a portion of the organization, procedure- and rule-making, and operational management activities associated with the club.

Club members may be rewarded for the referral at step 16 with “points” that may be accrued in an account maintained by the business in the member's name. The referred customer may also be rewarded by receiving a discount on their bill for that visit, or by other incentives or “members only” benefits.

In a restaurant setting the customer's order is taken by a service staff member of the business at step 14. The referring member may be awarded additional points at this step, the number of points corresponding in a predetermined manner associated with the amount and/or types of goods and/or services purchased by the customer. The customer's order of step 14 may be entered into the computer system electronically and transmitted to an appropriate order fulfillment point, such as, for example, a stockroom, a warehouse, bar or a kitchen. In one embodiment of the present invention, a plurality of wireless handheld computers may be linked to the computer system, permitting the business service staff to freely roam about the business and mingle with customers and members (collectively termed “patrons”) while entering orders. For example, the wait staff of a restaurant may use wireless handheld devices to enter meal orders in “real-time” as they are placed by patrons. The entered orders may be transmitted by wireless means to the computer system and automatically routed to the kitchen for fulfillment by a service staff. Likewise, the computer system may be used by the service staff to communicate with the wait staff. Continuing with the prior restaurant example, this feature would allow the kitchen to notify the wait staff when an order is ready to be served or if an order required clarification.

The customer, enjoying the experience at the business, may desire to become a member of the club at step 18. Upon application the prospective new member is first qualified in accordance with predetermined criteria and then issued an account for tracking accrued points at step 20. The new member may also be issued a form of membership identification at this step. In one embodiment of the present invention, the member identification may be in the form of a card, key fob, tag, label, jewelry, button or other object containing a machine-readable code, such as a bar code or conventional radio frequency identification (“RFID”) device. RFID devices are extremely small radio frequency (“RF”)-powered electronic “chips” that can be unobtrusively attached or embedded into the member identification object. RFID devices typically are provided with a non-volatile memory portion that may be remotely programmed with information at the time of issuance, such as the member's membership number and their personal and demographic information. The stored information may be later read by means of RF transmitters and receivers placed in relative proximity to the RFID device. The RF transmitter serves to remotely power the RFID device, query the device, and, if desired, send information to the device for storage in the memory portion. The receiver may be used to obtain data transmitted by the RFID device in response to a query from the transmitter. The receiver may be further coupled to the computer system to automatically store, track or route the information in a predetermined fashion, such as tracking and recording member visits. If an RFID device is utilized, step 12 may be accomplished automatically by means of one or more RF transmitters and receivers placed in various locations about the business, such as the parking lot and entrances, the transmitters and receivers being capable of detecting and reading the RFID device even if it is concealed in a purse, pocket, wallet, etc. of the member. RFID devices may also be used in conjunction with conventional. video displays and audio systems to automatically greet the entering member with an aural or visual greeting and even display that member's name on an electronic display for other patrons to view.

At step 22, the new member is given a supply of referral cards. The new member (and established members) may be re-supplied with cards at this step as needed. The member may enter his name on the cards and then distribute them to prospective members at step 24, encouraging them to patronize the business. Alternatively, the member may merely encourage friends and associates to mention the member's name when visiting the business and registering as per steps 10 and 12. Referred customers may be incentivized to provide the member's name or referral card at step 10 in exchange for discounts or other incentives.

The referral cards of step 22 may include RFID devices in the same manner as discussed above for member identification. Information stored on the RFID device may include, without limitation, referring member information and the number of times the referral card has been used. In an embodiment of the present invention the RFID tag may be automatically scanned upon entry of the customer to the establishment and the referring member's account credited accordingly. In addition, usage data may be updated on the referral card, such as decrementing a predetermined number representing the number of times the referral card may be used to obtain the associated benefits.

Of course, it is desirable that the member regularly patronize the business as well, as at step 26. The member's identity may be recorded upon entering the business at step 28 by mechanical or electronic means, such as an RFID device. The member may receive points for each visit at step 30. The member's presence may also be announced to the staff, members and customers at step 32. The announcement may be accomplished by any conventional aural or visual means, such as public address announcements and video displays.

The member's order is taken and entered at step 34 in the same manner as at step 14. The member's account may be further credited at step 30 with points corresponding in a predetermined manner associated with the types and amounts of goods and services purchased. For example, the member may receive points in proportion to the number of dollars spent. Additional incentive points may also be awarded, such as bonus points for purchases of sale items and specials. Another example incentive might be awarding of bonus points for visits and purchases during traditionally slow times as a way for the business to boost traffic. Still further examples may include birthdays, anniversaries, combination purchases such as accessory items, and extra points for members who have accrued an above-average number of points.

At step 36, awards and prizes may be given to members on the basis of their patronage and referral activity. The awards and prizes may be based on any criteria desired by the business. One example might be awarding prizes to members who accrue a threshold number of points cumulatively or over a predetermined period of time. In another example embodiment of the present invention members who have made the most referrals resulting in new customers and/or members over a predetermined period of time may be rewarded.

The club membership may be further comprised of various levels or tiers. For example, a plurality of tiers having increasing quantities of perks may be established wherein membership in the levels is dictated by the number of points accrued by the member cumulatively and/or during a period of time. Separate categories of membership may be established as desired to benefit the business. For example, membership categories may be established for investors and employees. Additional categories may be established for groups of potential customers to encourage their patronage.

A provision may be made for the member to interface with the computer system, for example, to disable recognition of their RFID for that visit, check on the balance of the accumulated points in their account, and sign up new members. The interface may be accomplished by any convenient wired or wireless means, such as a kiosk.

### EXAMPLE EMBODIMENT

A “core customer” program is designed to develop a core group of loyal customers who frequently patronize an establishment and refer their circle of influence to the venue. The patronage of these customers is tracked and recorded. In addition, a process is implemented to track their individual referral business. A recognition/reward program will establish loyalty, encourage repeat business and publish the individual referral business of core customers. The program will provide rewards for the highest referral customers and also for the process of referring. Above all the program is preferably simple and easily explained to effectively harness word-of-mouth advertising.

Core Customers

To become a core customer there will be an application process and dossier filled out. The intent of the application and dossier is to know about the customers to better serve them. There will be a nominal fee to sign up. Applications can be filled out on-site or submitted via an Internet web site or e-mail. Upon completion of the sign-up process, a core customer ID card will be issued with a corresponding core customer account number and containing an imbedded RFID tag with all of the dossier information.

There will be numerous benefits for frequent patrons including, but not limited to: discounts on food items; discounts on travel packages; free admission to bands, no cover charge; special VIP entrance, no line during busy times; free parking; staff recognition, “old school” hospitality; no-wait, expedited check out and referral capability.

Referral Business

Core customers will receive a welcome packet that will include features of the venue, upcoming events, instructions and benefits of the program, and a plurality of referral cards. Core customers will have the ability to refer a customer to the venue by two different means, either with a referral card or with the mention of the member's name by the referral. An integrated data recording and tracking capability using a computer system will allow for effective implementation of this plan.

The referral card will have an imbedded RFID tag with the core customers' information keyed as a “referral”. The card will be usable for a predetermined number of visits to the establishment. Referrals using the card will have several benefits, such as: discounts on food items; discounts on travel packages; free admission to bands, no cover charge; special VIP entrance, no line during busy times; and free parking.

The logistical application of the RFID tag allows for the seamless implementation of the program. Essentially, a core customer can pass along his benefits to a friend, associate or family member and let them ‘try out’ the venue. After a predetermined number of uses the card will cease to function. At this point the referral may choose to become a core customer to continue and expand the benefits.

If the core customer does not have a card available or is not in physical proximity to the referral, he or she can pass along a referral by having the individual give the wait staff his or her name. The name will be keyed into a wireless Personal Digital Assistant or Point of Sale device and the business will be linked to the respective core customer account. The name referral will include benefits like those available for customers presenting a referral card.

Recognition and Reward

It is desirable to acknowledge the active participants in the program. A monthly newsletter may be sent out to all core customers that will contain a summary of business for the month. Volume totals for personal and referral business will be summarized and tabulated, recognizing the top performers. Rewards will be given in the form of trips, which may include hotel accommodations and/or airfare.

In addition to rewarding the most active participants, rewards will be given for the ‘process’ of referring. A core customer party will be held periodically where a name will be drawn from all qualified core customers to win a vacation trip. To qualify, a core customer must have a minimum predetermined number of combined visits or referrals each month for a predetermined number of consecutive months. The winner may be required to be in attendance at the core customer party to win the drawing.

While this invention has been shown and described with respect to a detailed embodiment thereof, it will be understood by those skilled in the art that various changes in form and detail thereof may be made without departing from the scope of the claims of the invention.

What is claimed is:

1. A method for generating and/or increasing patronage at a business, comprising the steps of:
granting membership in a club sponsored by the business to applicants meeting predetermined membership criteria;
establishing a point account record for each member;
issuing at least one referral card to at least one member;
distributing at least one referral card from at least one member to at least one referral who is a prospective customer of the business;
crediting the point account of each member with a predetermined number of points for referrals who patronize the business and present the member's referral card or identify the member; and
issuing awards and/or prizes to members who accumulate a predetermined number of points.

2. The method of claim 1, further comprising the steps of:
granting membership in the club to referrals as referred members if they meet predetermined membership criteria;
establishing a point account record for each referred member;
issuing referral cards to each referred member;
crediting the account of each referred member with a predetermined number of points for referrals who patronize the business and provide the referral card to the business; and
providing incentives to the referral upon presentation of the referral card.

3. The method of claim 1, further comprising the step of crediting the member with a predetermined number of points when the member or a referral patronizes the business.

4. The method of claim 3 wherein the number of points credited to the member are associated in a predetermined manner to the types and/or amounts of goods and/or services purchased by the member.

5. The method of claim 3 wherein the number of points credited to the member are associated in a predetermined manner to the types and/or amounts of goods and/or services purchased by the referral.

6. The method of claim 1, further comprising the step of announcing the name of the member when the member patronizes the business.

7. The method of claim 1, further comprising the step of issuing membership identification to the members.

8. The method of claim 7 wherein the membership identification includes an RFID device.

9. The method of claim 8, further comprising the step of automatically detecting the patronage of a member by means of the RFID device.

10. The method of claim 9, further including the step of automatically crediting the account of the member with a predetermined number of points for patronizing the business.

11. The method of claim 1 wherein the referral card may be used for a predetermined number of visits to the business.

12. The method of claim 1 wherein the referral card includes an RFID device.

13. The method of claim 12, further including the steps of automatically:
detecting the patronage of a non-member customer;
obtaining information relating the referring member; and
crediting the account of the referring member with a predetermined number of points.

14. The method of claim 1 wherein membership in the club comprises tiers having greater and lesser privileges, the privileges corresponding in a predetermined manner to the referral and patronage activity of the members.

15. The method of claim 1, further comprising the step of providing members access to their accounts.

16. The method of claim 15 wherein the members are able to edit at least a portion of their account.

17. A method for generating and/or increasing patronage at a business, comprising the steps of:
granting membership in a club sponsored by the business to applicants meeting predetermined membership criteria;
establishing a point account record for each member;
issuing at least one referral card to at least one member;
distributing at least one referral card from at least one member to at least one referral who is a prospective customer of the business;
crediting the point account of each member with a predetermined number of points for referrals who patronize the business and present the member's referral card or identify the member;
issuing awards and/or prizes to members who accumulate a predetermined number of points;
granting membership in the club to referrals as referred members if they meet predetermined membership criteria;
establishing a point account record for each referred member;
issuing referral cards to each referred member;
crediting the account of each referred member with a predetermined number of points for referrals who patronize the business and present the referral card of the referred member to the business; and
providing incentives to the referral upon presentation of the referral card.

18. The method of claim 17, further comprising the step of crediting the member with a predetermined number of points when the member or a referral patronizes the business.

19. The method of claim 18 wherein the number of points credited to the member are associated in a predetermined manner to the types and/or amounts of goods and/or services purchased by the member.

20. The method of claim 18 wherein the number of points credited to the member are associated in a predetermined manner to the types and/or amounts of goods and/or services purchased by the referral.

21. The method of claim 17, further comprising the step of issuing membership identification to the members.

22. The method of claim 21 wherein the membership identification includes an RFID device.

23. The method of claim 22, further comprising the step of automatically detecting the patronage of a member by means of the RFID device.
